(19) United States
(12) Patent Application Publication
(10) Pub. No.: US 2002/0098832 A1
(43) Pub. Date: Jul. 25, 2002

(54) Intelligent personalized customer service

(76) Inventors: Wolfgang Fleischer, Naperville, IL (US); Chinmei Chen Lee, Woodbridge, IL (US); Zhibi Wang, Woodbridge, IL (US)

Correspondence Address: Walter W. Duft, Law Office of Walter W. Duft, 10255 Main Street, Suite 10, Clarence, NY, 14031, US

(21) Appl. No.: 09/766,925

(22) Filed: Jan. 22, 2001

(51) Int. Cl. H04M 3/42

(52) U.S. Cl. 455/414; 455/456

(57) ABSTRACT

A system for providing intelligent personalized customer service to a wireless terminal in a wireless telecommunication network is disclosed. Wireless terminal location is monitored and used to determine location-specific customer service information that is specific to the wireless terminal. The customer service information is delivered to the wireless terminal and displayed in human-readable form. The process is repeated as necessary to update the customer service information whenever the wireless terminal travels to a new location area.

### BACKGROUND OF THE INVENTION

1. Field of the Invention

This invention relates to wireless telecommunication systems. More particularly, the invention concerns the provision of consumer information via wireless terminals in a wireless telecommunication system.

2. Description of the Prior Art

Wireless telecommunication systems currently support the use of wireless terminals that are capable of both voice and data communication. These devices typically include an integrated wireless telephone and a software-controlled data terminal that implements a micro-browser for “web surfing” and other data communication activities. These features have been used to advantage by commercial entities, which have employed data network (e.g., Internet) servers to provide advertising content, mass notifications, and other customer service information via web page documents sent to micro-browser equipped wireless terminals. With their integrated telephony equipment, wireless terminals can request and receive such information while a subscriber is at any location served by the wireless network.

Using cookies or the like, customer service information can be personalized according to customer preferences. As far as known, however, the personalization of customer service information has not included exploitation of the mobile capabilities of wireless terminals, such that the information content varies according to wireless terminal location. Indeed, given the global nature of the Internet, customer service information provided by web servers and the like tends to be insensitive to recipient location, unless the recipient manually specifies his or her location to the information provider.

The advantages of location-dependent personalization of customer service information are several. For example, a traveling mobile subscriber could locate needed essentials, such as gasoline, at the best price in an unfamiliar city. Many other products and services could be similarly identified, allowing the consumer to determine the most competitive pricing.

What is required in light of the foregoing is a system that allows mobile subscribers in a wireless communication system to obtain personalized customer service information based on their location, without requiring manual specification of location. What would be particularly advantageous is a system that uses the mobile location capabilities of the wireless communication network to provide such service.

### SUMMARY OF THE INVENTION

The foregoing problems are solved and an advance in the art is obtained by a novel system and method for providing intelligent personalized customer service to a wireless terminal in a wireless telecommunication network. According to this system and method, wireless terminal location is monitored and used to determine location-specific customer service information that is personalized relative to the wireless terminal subscriber. The customer service information is delivered to the wireless terminal and displayed in human-readable form. The process is repeated as necessary to update the customer service information when the wireless terminal travels to a new location area. The customer service information can represent any category of information but preferably comprises product information and is based on customer specification of one or more product categories.

In preferred embodiments of the invention, the monitoring of wireless terminal location includes requesting mobile location update events from a wireless network mobile location server and monitoring said update events as they are received. The monitoring process may further include determining whether a change in location of the wireless terminal exceeds a location area size threshold specified by the wireless subscriber (e.g., the customer wants the best gasoline price within a five mile radius of their location). The customer service information determining step can be implemented by consulting a customer profile database to determine a category (there may be more than one category) of customer service information specified by a customer and thereafter consulting one or more databases containing location-specific customer service information. Delivery of the customer service information to the wireless terminal preferably includes formatting the information as an electronic document. In that case, the customer service information can be easily displayed on a text-based or graphical display screen associated with the wireless terminal.

In another aspect of the invention, a wireless network resource group provides intelligent personalized customer service to wireless terminals in cooperation with a data network resource group in a data network. The wireless network resource group includes a set of wireless network resources that support data communication on behalf of a plurality of wireless terminals over an air interface. A wireless network mobile location server maintains location information for the wireless terminals. It is also adapted to receive a request from a data network application server to report wireless terminal location changes to the application server. In response to this request, the mobile location server sets a location update event notification flag, and thereafter notifies the application server of wireless terminal location changes.

In a further aspect of the invention, a data network resource group provides intelligent personalized customer service to wireless terminals in cooperation with a wireless network resource group in a wireless network. The data network resource group includes a user profile server adapted to store user profile information, one or more vendor inventory servers adapted to store location-specific customer service information, and an application server that manages and controls the personalized customer service. The application server is adapted to register requests from wireless terminals for personalized customer service. It also monitors wireless terminal location information provided by a wireless network mobile location server. In response to a triggering event such as a wireless terminal location change, the application server uses the information in the user profile server to obtain the location-specific customer service information from the one or more vendor inventory servers. The application server then outputs the location-specific customer service information for delivery to wireless terminals.

In yet another aspect of the invention, a data network application server provides intelligent personalized customer service to a wireless terminal. To provide such service, the application server receives wireless terminal location information, queries a user profile server to identify user profile information relative to the wireless user, queries a vendor inventory server selected according to the user profile information, receives personalized customer service information in response to the query, and outputs the personalized customer service information for delivery to the wireless terminal.

In yet another aspect of the invention, a data network user profile server supports intelligent personalized customer service to a wireless terminal in a wireless network. The user profile server includes a graphical user interface adapted to prompt for and receive customer service information. A data storage resource associated with the user profile server stores the customer service information as user profile information. The user profile server is also responsive to user profile information queries from a data network application server.

### BRIEF DESCRIPTION OF THE DRAWING

The foregoing and other features and advantages of the invention will be apparent from the following more particular description of preferred embodiments of the invention, as illustrated in the accompanying Drawing, in which:

FIG. 1 is a functional block diagram showing a network architecture for a wireless telecommunication system that provides intelligent personalized customer service in accordance with the invention; and

FIG. 2 is a flow diagram showing a series of method steps performed to implement intelligent personalized customer service in accordance with the invention.

### DETAILED DESCRIPTION OF THE PREFERRED EMBODIMENT

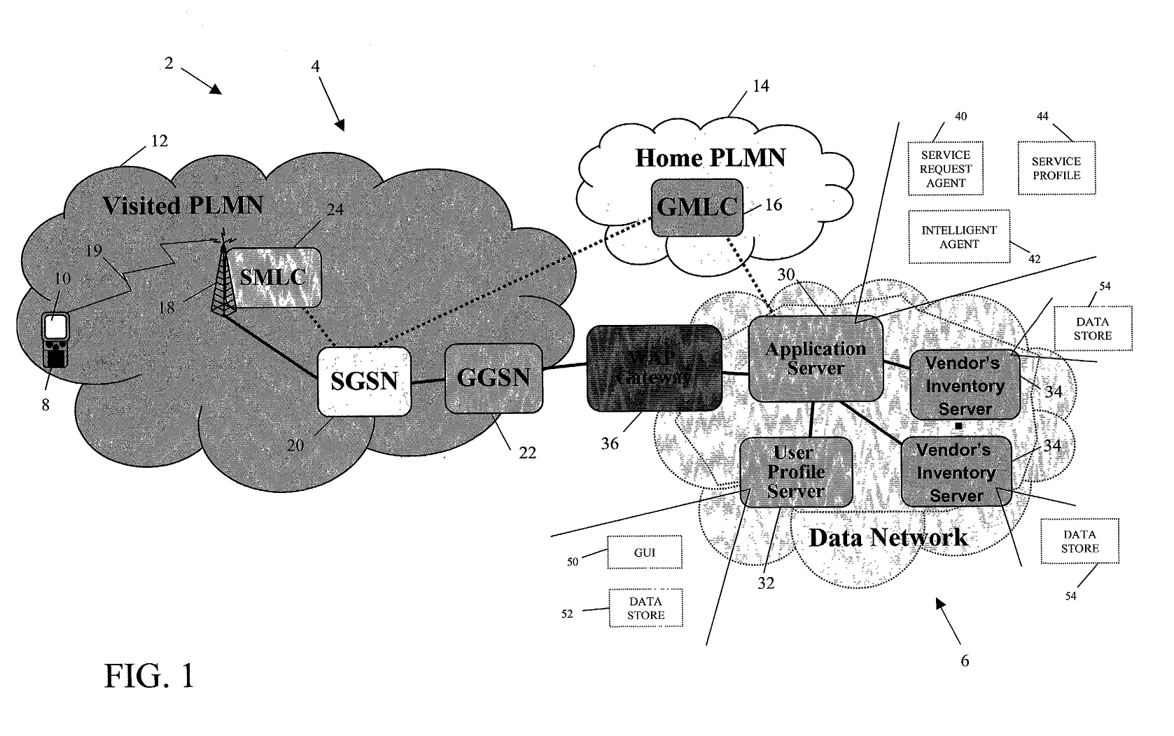

Turning now to the figures, wherein like reference numerals represent like elements in all of the several views, FIG. 1 illustrates a network architecture for a telecommunication system 2 that provides intelligent personalized customer service in accordance with the present invention. As shown, the telecommunication system 2 includes a wireless network resource group 4 and a data network resource group 6. The wireless network resource group 4 may be implemented in a conventional wireless telephone network that has been enhanced to carry data. A wireless network capable of carrying circuit-switched data could be used for this purpose. More preferably, however, the wireless network resource group 4 provides packet-switched data service. Examples of such wireless infrastructures include UMTS (Universal Mobile Telephone System), a “3^{rd} Generation” wireless system based on GSM (Global System for Mobile communications). GSM contemplates the addition of a packet network overlay known as GRPS (GSM Packet Radio Service) to a wireless voice network. It is thus ideally suited for implementing the wireless network resource group 4 of FIG. 1. The data network resource group 6 of FIG. 1 can be implemented using a conventional packet data network based on the IP (Internet Protocol) and/or ATM (Asynchronous Transfer Mode) protocols, and which also has wireless network access capability.

In the architecture of FIG. 1, a wireless terminal 8 is assumed to include an integrated wireless transceiver for voice and data delivery, and a software-controlled data terminal that includes a display 10. The wireless terminal 8 should be capable of displaying text messages, and may also implement a graphical user interface, such as a web browser or the like. By way of example only, the wireless terminal 8 could implement a WAP (Wireless Application Protocol) micro-browser to display WML (WAP Markup Language) documents. There are a variety of suitable wireless terminal products on the market today, and others in development. These include WAP enabled telephones, PDAs (Personal Digital Assistants), handheld computers, pagers and the like.

In FIG. 1, the wireless terminal 8 is further assumed to be roaming in an area that is remote from its normal operating area. As such, the wireless network resource group 4 is shown as including a visited PLMN (Public Land-based Mobile Network) 12 and a home PLMN 14. The home PLMN 14 serves the wireless terminal's normal operating area and the visited PLMN 12 serves the wireless terminal's roaming area. The home PLMN 14 includes a home mobile location server 16 that bears the UMTS designation “GMLC” (Gateway Mobile Location Center) insofar as FIG. 1 is intended to exemplify an UMTS implementation of the wireless network resource group 4. Other wireless network standards may assign other names to the mobile location resource server 16. Regardless of the implementation-specific name applied, it is anticipated that the home mobile location server 16 will implement a conventional HLR (Home Location Register) function that maintains generalized location information about wireless terminals under its jurisdiction (i.e., the network and vicinity of a mobile, such as the mobile's current location/routing area). The home mobile location server 16 can also track intra-network (i.e., cell-to-cell) mobile terminal movement by initiating queries of base station resources in a mobile terminal's current PLMN, as described in more detail below. The home mobile location server 16 further includes an interworking function for communicating wireless terminal location information to the data network resource group 6, and maintains an interface with an application server (see below) in the data network resource group. Via this interface, the home mobile location server 16 sets a location update notification flag (at the request of the application server) and notifies the application server whenever a mobile terminal location change causes an update to the mobile location server's database. The location change may be a change from one visited PLMN to another, or a change from one cell to another within the same PLMN. In an optional implementation, movements within a cell might also be tracked if a GPS (Global Positioning System) device is incorporated in the wireless terminal 8.

The visited PLMN 12 includes a cell Base Station 18, a data switching node, 20, a data network gateway 22, and a visitor mobile location server 24. The base station 18 communicates over an air interface 19 with the wireless terminal 8. The data switching node 20 is labeled “SGSN” (Serving GPRS Support Node) in FIG. 1 according to the UMTS designation for this component. Other wireless network standards may use other names. For example, the ANSI-41 standard for CDMA (Code Division Multiple Access) data networks use the terms “PCF” (Packet Control Function) and “PDSN” (Packet Data Serving Node). Regardless of the implementation specific name applied, the data switching node 20 is a conventional entity with mobility support capability that routes data traffic between the base station 18 and the data network resource group 6. The data switching node 20 also performs a conventional VLR (Visitor Location Register) function. It therefore reports to the HLR function of the home mobile location server 16 whenever the mobile terminal 8 is operating within the jurisdiction of the visited PLMN 12.

The data network gateway 22 is labeled “GGSN” (Gateway GPRS Support Node) in FIG. 1, according to the UMTS designation for this component. Other wireless network standards may use other names. For example, the ANSI-41 standard for CDMA (Code Division Multiple Access) data networks use the term “PDSN” (Packet Data Serving Node). Regardless of the implementation specific name applied, the data network gateway 22 is a conventional entity that serves as a gateway that allows the wireless network resource group 4 to communicate with the data network resource group 6. The visitor mobile location server 24 is labeled “SMLC” (Serving Mobile Location Center) in FIG. 1 according to the UMTS designation for this component. Other wireless network standards may use other names. Regardless of the implementation specific name applied, the visitor mobile location server 24 will typically be associated with the base station 18, and there will therefore be multiple visitor mobile location servers in the visited PLMN 12 (one at each base station). The visitor mobile location server 24 has the ability to report the cell location of the wireless terminal 8 (via the data switching node 20) to the home mobile location server 16. This can be done upon request from the home mobile location server 16. In particular, when the data network application server (see below) requests the location of a mobile terminal from the home mobile location server 16, the latter consults its HLR database to identify the data switching node where the mobile terminal is currently registered for packet services. The home mobile location server 16 sends a location request to the identified data switching node, which node has information about the base station that currently serves the mobile terminal. The data switching node relays the request to the base station's visitor mobile location server and the latter's response is sent via the data switching node back to the home mobile location server 16. In an alternative approach, the visitor mobile location servers could be programmed to report to the home mobile location server 16 (via the data switching node 20) whenever a mobile terminal enters or leaves their jurisdiction. Note that this would eliminate the need for location polling initiated by the home mobile location server 16. However, a significant reprogramming effort may be required to enable a conventional data switching node to perform this function.

The data network resource group 6 of FIG. 1 includes a data network application server 30, a user profile server 32, plural vendor inventory servers 34, and a wireless network gateway 36. Note that the wireless network gateway 36 is designated as a “WAP Gateway” in FIG. 1 for purposes of illustration only, it being understood that a WAP implementation of the invention represents only one possible embodiment thereof. The application server 30 includes three main functional components; namely, a service request agent 40, an intelligent service logic agent (intelligent agent) 42, and a service profile 44. As previously described, the application server 30 also maintains an interface with the mobile location server 16. This interface is used by the application server 30 to request notification of mobile terminal location changes. The application server 30 similarly maintains interfaces with the user profile server 32 and the vendor inventory servers 34. Note that each of these interfaces can be advantageously based on commonly used IETF (Internet Engineering Task Force)/W3C (World Wide Web Consortium) specifications, such as XML (eXtensible Markup Language) over HTTP (HyperText Transfer Protocol), etc.

The user profile server 32 is a data network entity that stores user profile information provided by a wireless subscriber. It includes a GUI (Graphical User Interface 50 (preferably implemented as one or more WWW web pages) that is programmed to prompt for and receive input regarding the customer service information desired by the subscriber. For example, if the subscriber wishes to be informed about consumer products or services, the user profile information may include product or service type, vendor, etc. The user profile information preferably also includes location area size information. For example, the customer may wish to be notified about prices for a particular product or service within five miles or (some other specified radius) of the subscriber's physical location. A data storage resource 52 associated with the user profile server 32 stores the user profile information received via the GUI 50. An interface in the user profile server is responsive to user profile information queries from the application server 30 and provides user profile information thereto upon request.

The vendor inventory servers 34 are data network resources operated by participating vendors. These vendors maintain inventory databases 54 containing vendor product information by location. For example, an oil company could implement a vendor inventory server 34 containing gasoline pump prices by city, county, state, or the like. This information would also typically include the name, address and telephone number of each listed retail location, and various product descriptions.

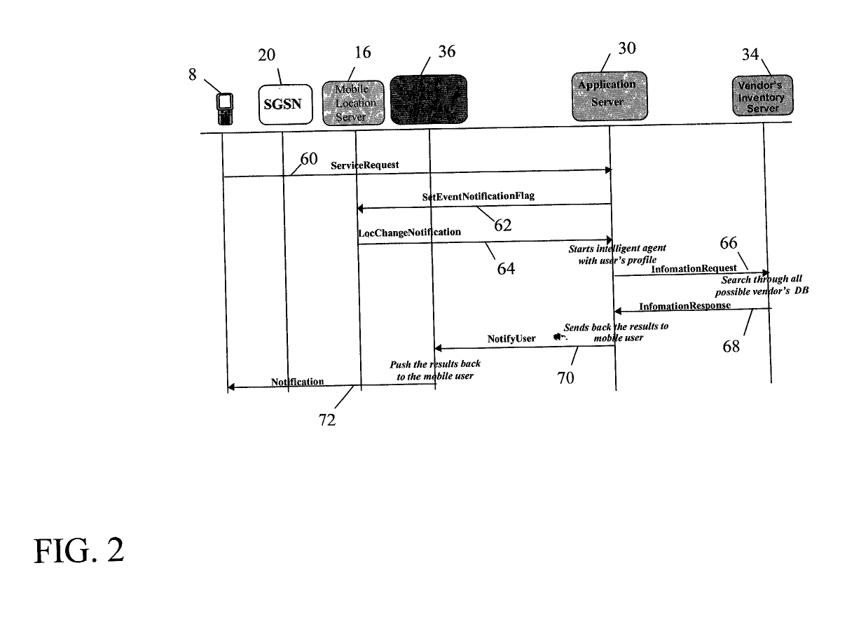

With additional reference now to FIG. 2, the foregoing entities of the wireless network resource group 4 and the data network resource group 6 are adapted to support intelligent personalized customer service in the following manner. Suppose that a mobile subscriber operating the mobile terminal 8 wishes to look for a consumer product at a pre-defined price within a certain radius of the mobile terminal's current location. Prior to invoking service, the mobile subscriber must obtain a service subscription and establish a user profile. Although this can be done in a variety of ways, the most likely scenario is that the subscriber would access a URL [that she got from, say, an advertisement] to sign up for the service by entering information such as name, billing address, email address, initial user service profile, etc. The business oriented information such as name, address may be forwarded to the business side of the service; and service profile information gets stored in the user profile server 32. For the subscriber to manage her profile, a URL which may be the same or different from the one mentioned above can be accessed to do so. A profile management session can be performed whereby the new subscriber is able to specify his or her user profile information. Note that the subscriber will typically use the wireless terminal 8 to subscribe to service and establish a user profile. Alternatively, the subscriber could perform these tasks using any other suitable network device, such as a personal computer or the like. It is desirable to allow wireless subscribers to request on demand that their profiles be updated to reflect their current interests. For that reason, the wireless terminal 8 can be programmed to provide a menu or the like that allows the subscriber to perform profile management on demand.

Having subscribed for service and established a profile, a mobile subscriber can initiate service by making a service request from the wireless terminal 8 to the application server 30. This is shown in step 60 of FIG. 2. How the wireless terminal 8 allows the subscriber to request service is a matter of design choice. For example, the wireless terminal 8 could display a menu that allows the subscriber to make the service request. Alternatively, the wireless terminal 8 could have a dedicated pushbutton for requesting service. In any event, when the service request is made, the wireless terminal 8 will communicate the request to the application server 30. The application server 30 will then take several actions to implement service. One such action is for the intelligent agent 42 to instruct the mobile location server 16 to set an event notification flag and to notify the intelligent agent 42 whenever a mobile terminal changes location. This is shown in step 62 of FIG. 2. Typically, a cell change will be the triggering event. To that end, the home mobile location server 16 will check its HLR database to identify the wireless terminal's network location (e.g., the visited PLMN 12), and issue a query to the visited PLMN for cell location information. For example, in an UMTS implementation, a cell site query would be issued by the home mobile location server 16 and relayed by the data switching node 20 to the visitor mobile location server 24 of the serving base station 18. Note that location granularities of smaller or larger size could be used, and can be based on a location area size parameter or a product/service identification specified by a subscriber as part of the subscriber's profile. As an example of location area size specification, the subscriber might specify a location area size that is so large that only movements from one PLMN to another need to be tracked. Alternatively, the subscriber might specify a location area size that is so small that intra-cell movements must be tracked (requiring a GPS device or the like). As an example of product/service identification, the subscriber might specify a product such as real estate that allows for fairly large location granularity. The same subscriber might later specify a product such as gasoline that requires relatively small location granularity.

Pursuant to the event notification flag set per request of the application server 30, the home mobile location server 16 will report the wireless terminal's location change information when a location change has occurred. Such a location change notification is received by the application server 30 in step 64 of FIG. 2. This causes several things to happen. First, the intelligent agent 42 consults the service profile 44 to determine whether a customer information request needs to be made to any of the vendor inventory servers. To that end, the service profile 44 can be provisioned to define geographic service areas that correlate with the mobile terminal location information provided by the mobile location server 16. Only when a mobile terminal crosses from one service area to another would a new customer information request be performed. Each service area definition in the service profile 44 could contain information about the actual wireless cells, PLMNs, etc. that it encompasses, allowing rapid determination of the subscriber's service area location. An additional benefit of defining service areas in the service profile 44 is that geographic information, rather than cellular information, can be specified to the vendor inventory servers 34 as part of a customer information query. By way of example, it is easier to ask a vendor inventory server 34 for all retail locations serving the Toledo, Ohio area than it is to request information based on wireless network PLMN location data.

Once the intelligent agent 42 determines that a mobile terminal's location warrants a customer information update, one or more customer information requests are made in step 66 to the vendor inventory server(s) 34 of interest. Determination of the appropriate vendor inventory server(s) 34 requires that the intelligent agent 42 consult the user profile server 32 to determine the products or services specified by the subscriber. To further facilitate queries of the vendor inventory server(s) 34, the service area information maintained by the service profile 44 may include a listing of participating vendors offering products or services in that area. This can be useful for limiting the number of vendor inventory server lookups insofar as only vendors who offer products or services within range of the subscriber are consulted. As a further expedient, the service profile 44 could maintain a list of products and services associated with particular vendors, such that only vendors with products or services of interest are consulted.

In step 68, the vendor inventory server(s) 34 queried by the application server 30 respond(s) with appropriate customer service information. In step 70, the application server 30 formats the customer service information as necessary and sends it to the mobile terminal 8 via the wireless network gateway 36. In a WAP implementation of the invention, the application server 30 acts as a WAP content server that is programmed to form a document, such as a WML document, containing the customer service information content. If the information is in a document format other than WML, such as HTML), the wireless network gateway 36 can adapt the document based on the WAE (Wireless Application Environment) specifications, or the like, to facilitate display at the wireless terminals 8.

In step 72 of FIG. 2, the wireless network gateway 36 delivers the WML document containing the customer service information to the mobile terminal 8. In a WAP implementation of the invention, the wireless terminal 8 will be a WAP-enabled client that interprets the WML document and displays the customer service information to the subscriber on the display 10. Note that other interface formats between the application server 30 and the wireless terminal 8 could also be used, including HTML (Hypertext Markup Langugage, xHTML (extensible HTML), or cHTML (compact HTML) over HTTP or WSP (WAP Session Protocol).

Accordingly, novel system and method for providing intelligent personalized customer service are disclosed. The disclosed service advantageously allows mobile subscribers to obtain comparative consumer product information based on mobile terminal location. If a mobile user wishes to find a competitive price for a specific consumer product based on the location where the mobile user is located, the mobile user can subscribe to this service and have the product preference provisioned in the user profile server 32. When a service request is made, the application server 30 launches the intelligent agent 42 on behalf of the mobile user, which can be programmed to search for competing vendors' inventory within a certain range of the mobile terminal's current position and select the most competitive vendor. If a match is found, the application server 30 will be notified, and it will then deliver a message to the mobile terminal to inform the user of the winning vendor's location and product or service information, including price, etc.

While various embodiments of the invention have been described, it should be apparent that many variations and alternative embodiments could be implemented in accordance with the invention. It is understood, therefore, that the invention is not to be in any way limited except in accordance with the spirit of the appended claims and their equivalents.

What is claimed is:

1. A method for providing intelligent personalized customer service to a wireless terminal in a wireless telecommunication network, comprising the steps of:
monitoring wireless terminal location;
using said wireless terminal location to determine location-specific customer service information for delivery to said wireless terminal; and
delivering said customer service information to said wireless terminal.

2. A method in accordance with claim 1 wherein said customer service information comprises product information.

3. A method in accordance with claim 1 wherein said customer service information is determined based on customer specification of one or more information categories.

4. A method in accordance with claim 1 wherein said monitoring step includes requesting mobile location update events from a wireless network mobile location server and monitoring said update events as they are received.

5. A method in accordance with claim 1 wherein said monitoring step includes determining whether a change in location of said wireless terminal exceeds a location area size threshold.

6. A method in accordance with claim 5 wherein said location area threshold is based on customer specification of location area size.

7. A method in accordance with claim 1 wherein said customer service information determining step includes consulting one or more databases containing location-specific customer service information.

8. A method in accordance with claim 7 wherein said customer service information determining step further includes consulting a customer profile database to determine a category of customer service information specified by a customer.

9. A method in accordance with claim 1 wherein said delivering step includes delivering said customer service information to said wireless terminal as an electronic document.

10. A method in accordance with claim 1 further including displaying said customer service information on a text-based or graphical display screen.

11. A system for providing intelligent personalized customer service to a wireless terminal, comprising:
means for monitoring wireless terminal location;
means for using said wireless terminal location to determine location-specific customer service information for delivery to said wireless terminal; and
means for delivering said customer service information to said wireless terminal.

12. A system in accordance with claim 11 wherein said customer service information comprises product information.

13. A system in accordance with claim 11 wherein said customer service information is determined based on customer specification of one or more information categories.

14. A system in accordance with claim 1 wherein said monitoring means includes means for requesting mobile location update events from a wireless network mobile location server and monitoring said update events as they are received.

15. A system in accordance with claim 11 wherein said monitoring means includes means for determining whether a change in location of said wireless terminal exceeds a location area size threshold.

16. A system in accordance with claim 15 wherein said location area threshold is based on customer specification of location area size.

17. A system in accordance with claim 11 wherein said customer service information determining means includes means for consulting one or more databases containing location-specific customer service information.

18. A system in accordance with claim 17 wherein said customer service information determining means further includes consulting a customer profile database to determine a category of customer service information specified by a customer.

19. A system in accordance with claim 11 wherein said delivering means includes means for delivering said customer service information to said wireless terminal as an electronic document.

20. A system in accordance with claim 11 wherein said wireless terminal includes displaying means for displaying said customer service information on a text-based or graphical display screen.

21. A wireless network resource group for providing intelligent personalized customer service to wireless terminals in cooperation with a data network resource group in a data network, comprising:
a set of wireless network resources supporting data communication on behalf of a plurality of wireless terminals over an air interface;
a mobile location server adapted to maintain location information for said wireless terminals;
first means in said mobile location server for receiving a request from a data network application server to report wireless terminal location changes to said data network resource;
second means in said mobile location server for setting a location update event notification flag in response to receiving said request from said data network application server; and
third means in said mobile location server for periodically notifying said data network application server of wireless terminal location changes.

22. A data network resource group for providing intelligent personalized customer service to wireless terminals in cooperation with a wireless network resource group in a wireless network, comprising:
a user profile server adapted to store user profile information;
a vendor inventory server adapted to store location-specific customer service information;
an application server adapted to manage said personalized customer service;
a service request agent associated with said application server for registering requests from wireless terminals for personalized customer service;
a service profile associated with said application server containing service area information;
an intelligent agent associated with said application server for monitoring wireless terminal location information provided by a mobile location server and for comparing said location information with said service area information;
said intelligent agent being further adapted to obtain said user profile information from said first data network resource;
said intelligent agent being further adapted to obtain said location-specific customer service information from said vendor inventory server; and
a document formatter for outputting said location-specific customer service information for delivery to wireless terminals.

23. In a data network wireless telephony application server, a method for providing intelligent personalized customer service to a wireless terminal, comprising the steps of:
receiving wireless terminal location information;
querying a user profile server to identify user profile information relative to said wireless terminal;
querying a vendor inventory server selected according to said user profile information and receiving personalized customer service information in response to said query; and
outputting said personalized customer service information for delivery to said wireless terminal.

24. A data network wireless telephony application server adapted to provide intelligent personalized customer service to a wireless terminal, comprising:
means for receiving wireless terminal location information;
means for querying a user profile server to identify user profile information relative to said wireless terminal;
means for querying a vendor inventory server selected according to said user profile information and receiving personalized customer service information in response to said query; and
means for outputting said personalized customer service information for delivery to said wireless terminal.

25. A data network user profile server for supporting intelligent personalized customer service to a wireless terminal in a wireless network, comprising:
a graphical user interface adapted to prompt for and receive customer service information;
a data storage resource for storing said customer service information as user profile information; and
said user profile server being responsive to user profile information queries from a data network query requester.
